(19) United States
(12) Patent Application Publication
(10) Pub. No.: US 2019/0384460 A1
(43) Pub. Date: Dec. 19, 2019

(54) SURFACING APPLICATION FUNCTIONALITY FOR AN OBJECT

(71) Applicant: Microsoft Technology Licensing, LLC, Redmond, WA (US)

(72) Inventors: Michael Edward HARNISCH, Seattle, WA (US); Bojana OSTOJIC, Seattle, WA (US); Liang CHEN, Bellevue, WA (US); Jose Alberto RODRIGUEZ, Seattle, WA (US); Steven Douglas DEMAR, Redmond, WA (US); Lori Beth KRATZER, Carnation, WA (US)

(21) Appl. No.: 16/008,889

(22) Filed: Jun. 14, 2018

(51) Int. Cl. G06F 3/0482

(52) U.S. Cl. CPC G06F 3/0482; G06F 3/04817

(57) ABSTRACT

The disclosed technology surfaces application functionality for an object in a user interface of a computing device. A context associated with the object is determined. A contextual tool window of the user interface presents the user interfaces for one or more functions of one or more applications, based on the context, without launching any of the one or more applications in an application window. Selection by a user of one of the presented one or more functions is detected through the contextual tool window in the user interface. The selected function is executed on the object without launching any of the one or more applications in an application window.

### Cross-reference to Related Applications

The present application is related to U.S. application Ser. No. ______ [Docket No. 404361-US-NP], entitled “Inter-application Context Seeding”; U.S. application Ser. No. ______ [Docket No. 404363-US-NP], entitled “Next Operation Prediction for a Workflow”; and U.S. application Ser. No. ______ [Docket No. 404710-US-NP], entitled “Predictive Application Functionality Surfacing,” all of which are concurrently filed herewith and incorporated herein by reference for all that they disclose and teach.

### BACKGROUND

In a desktop, mobile, or mixed/virtual reality environment, data elements are stored as objects, such as a file in a file system or a visible 2D or 3D object accessible in a mixed/virtual reality space. Often, however, an application capable of operating on the object is separate from the object and typically not visible with the object in the environment. For example, a file resides in a file system and is visible in a folder of the file system. Any application capable of operating on the file is likely to reside elsewhere in the file system, such as in a separate applications folder. Further, the functionality applicable to an object, such as a print function, is often hidden within the applications and not easily discoverable. In a mixed/virtual reality environment, the separateness can be even more pronounced because the environment can present objects through a user interface to the user without any visible association with specific functionality. As such, having encountered an object in a file system or a mixed/virtual reality environment, the user must typically interrupt his or her workflow to locate or trigger or invoke a separate application and specific functionality to operate on that object.

### SUMMARY

In at least one implementation, the disclosed technology surfaces application functionality for an object in a user interface of a computing device. A context associated with the object is determined. A contextual tool window of the user interface presents the user interfaces for one or more functions of one or more applications, based on the context, without launching any of the one or more applications in an application window. Selection by a user of one of the presented one or more functions is detected through the contextual tool window in the user interface. The selected function is executed on the object without launching any of the one or more applications in an application window.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example mixed/virtual reality environment capable of surfacing application functionality for an object associated with a selected icon.

FIG. 2 illustrates an example mixed/virtual reality environment capable of selecting application functions for an object associated with a selected icon via a context menu presenting available functions from multiple applications.

FIG. 3 illustrates an example mixed/virtual reality environment capable of surfacing application functionality for an object associated with a selected icon through a contextual tool window.

FIG. 4 illustrates an example mixed/virtual reality environment capable of surfacing application functionality for a selected object.

FIG. 5 illustrates an example mixed/virtual reality environment capable of surfacing application functionality for a selected object.

FIG. 6 illustrates an example desktop environment capable of surfacing application functionality for a selected object in an application through a separate contextual tool window, in a pre-operation phase.

FIG. 7 illustrates an example desktop environment capable of surfacing application functionality for a selected object in an application through a separate contextual tool window, in a post-operation phase.

FIG. 8 illustrates an example flow of operations for surfacing application functionality for an object.

FIG. 9 illustrates an example system for surfacing application functionality for an object.

FIG. 10 illustrates example operations for surfacing application functionality for an object.

FIG. 11 illustrates an example computing device that may be useful in implementing the described technology.

### DETAILED DESCRIPTIONS

As will be described in more detail, the described technology relates to predictive surfacing of application functionality associated with an object in a user interface (UI) of a computing environment, such as a desktop, mobile, or mixed/virtual reality environment. Application functionality of an application includes any function or command available within the application that can be presented through a contextual tool window in a user interface. In some implementations, all functions of one or more applications may be available for predictive surfacing of their user interfaces. In other implementations, a subset of functions of one or more applications is available for predictive surfacing of their user interfaces. In yet other implementations, functions of multiple applications may be available for predictive surfacing of their user interfaces.

Predictive surfacing of application functionality presents user interface elements for application functionality in a contextual tool window separate from the associated application itself. The computing system need not launch the associated application or switch focus to the associated application (e.g., if already launched). “Launching” means executing the application in an application window from a non-executing state. “Switching focus” means bringing the application window of an already-launched application to the front (e.g., in the sense of a Z-axis orthogonal to the display plane) of the user interface.

The separate contextual tool window may be executed by a separate processing thread than that of the active application window and yet display user interface elements for functionality (e.g., a “next” function the user might like to use) of the active application. The presented controls correspond to one or more predicted next functions based on a context, such as the object type or monitored user activity (e.g., the current user or a selection of other users). For example, when a user selects an icon for an image object in a desktop user interface, predictive surfacing of application functionality may predict that the next function will be to adjust the color, size, or resolution in the corresponding image. User interface elements for adjusting the color, size, and/or resolution of the corresponding image may, therefore, be presented in the user interface. In one implementation, user activity within the user interface or with the corresponding object or similar objects may be tracked over time to aid in predicting the next function. For example, if a user frequently selects an image object and then adjusts the color of the image, a user interface from an application for adjusting color within the image may be presented in a contextual tool window when the user selects the icon for the image object. The resulting adjustment to the image may be presented in the contextual tool window or some other user interface element.

Further, user activity may be tracked across applications, and predictions may be based on the applications with which the user is interacting. For example, image filter functionality may be surfaced when a user pastes an image into a presentation editing application from an image gallery application. However, the image filter functionality may not be surfaced when a user pastes the same image into photo editing application instead of a presentation editing application, depending on the prediction and related context.

The predictive surfacing of application functionality can be implemented through machine learning, although other prediction techniques may be implemented. A machine learning module may initially make predictions based on generic preferences. Over time, the machine learning module may make predictions based on the functions a user typically selects after a specific user activity or series of user activities. Predictive surfacing of application functionality may occur in a variety of computing environments including, without limitation, traditional operating systems, mobile computing environments, and virtual reality (VR) environments.

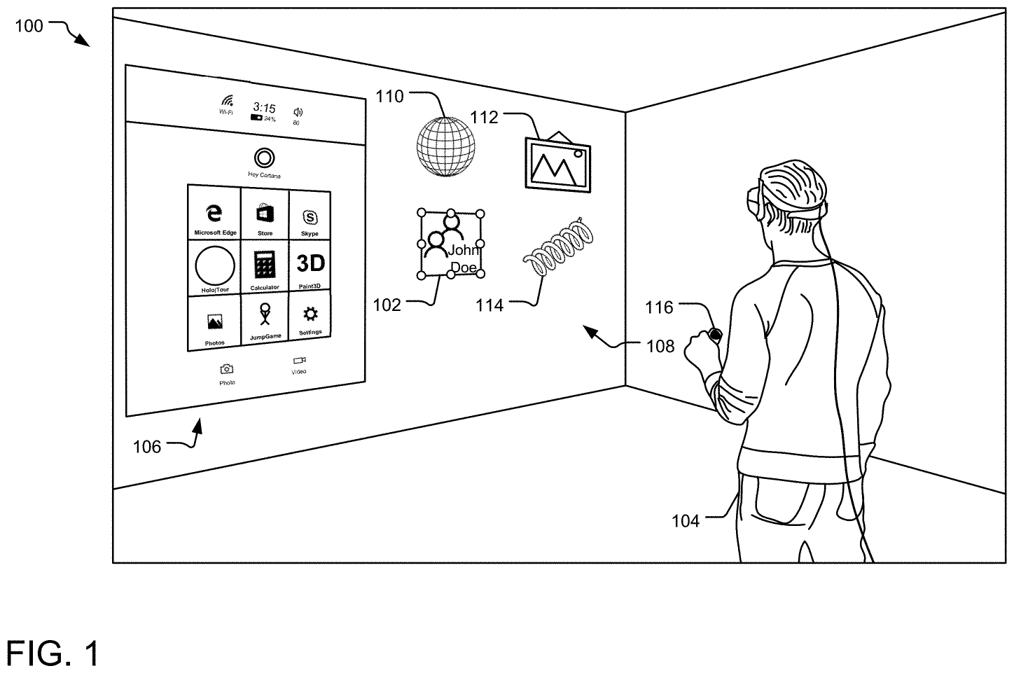

FIG. 1 illustrates an example mixed/virtual reality environment 100 capable of surfacing application functionality for an object associated with a selected icon 102. A user 104 is working in the mixed/virtual reality environment 100 and is presented with a palette 106 of application icons and a set 108 of object icons. The palette 106 presents information (e.g., time, battery charge) and icons for various applications, including a browser, an application store, a communication tool, a photo gallery, and a video camera. The application icons represent control capable of launching corresponding applications, but none of the applications are shown as launched in FIG. 1—the palette 106 merely provides static controls from which such applications may be launched into the environment 100.

In contrast, the object icons of the set 108 represent data objects within the mixed/virtual reality environment 100, much like a data file or folder in a file system. In FIG. 1, the selected icon 102 represents a contact (e.g., as a v-card or other contact object). The icon 110 represents a 3D object; the icon 112 represents a photo object; the icon 114 represents a computer-aided design (CAD) object. Each data object may be associated with one or more applications or operating system functions, but the object icons in the set 108 do not represent launched applications.

The user 104 selects the icon 102 to perform some type of function on the associated data object. Selection of the icon 102 represents giving the associated object focus, and may be accomplished through a variety of mechanisms, including using a VR control 116 to move focus to or select the icon 102 (e.g., as shown by the circles distributed around the icon 102, tabbing focus to the icon 102 using a virtual keyboard). In a typical user scenario, the user 104 could launch an application to provide functionality on the object associated with the icon 102 (e.g., dragging the icon 102 on an application icon in the palette 106, double-clicking a pointing cursor on to launch an application associated with the type of the data object). However, simply moving focus to the icon 102 does not launch an application or any other application functionality of the associated data object. Selecting an icon associated with an object is also referred to as “selecting the object.”

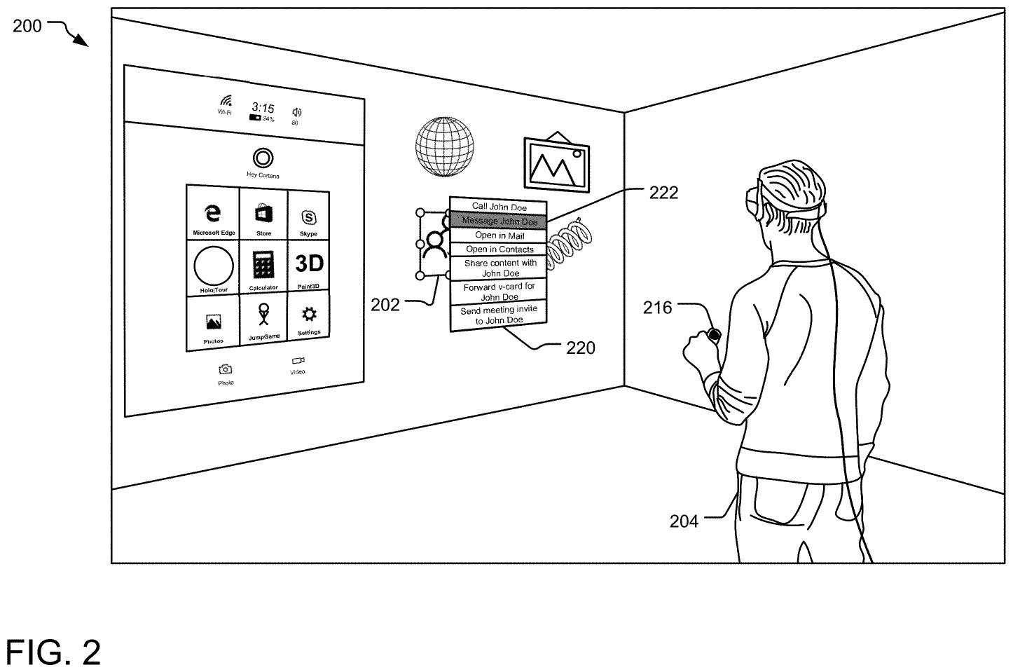

FIG. 2 illustrates an example mixed/virtual reality environment 200 capable of surfacing application functions for an object associated with a selected icon 202 via a context menu 220 presenting available functions from multiple applications. In the illustrated example, the object has an object type of “contact card,” “v-card,” or some similar type.

The user 204 can access the user interfaces for functionality from one or more applications through the icon 202 for the object without launching the corresponding application in an application window or even switching focus to an application window of an already launched application. For example, using a control on a VR control 216 (e.g., an equivalent of a right-click on a mouse), the user 204 can trigger the context menu 220, which presents a selection of available functions from a phone application, a messaging application, a mail application, a contacts application, etc. In various implementations, the applications and/or functions available for the object associated with the icon 202 have registered with the object type of the object associated with icon 202. In various implementations, the object type of an object can be discovered through an object manager, a registry, a database manager, a file name suffix or extension, or some other executive function of an operating system or application. Object types may take many forms, including without limitation a file protocol (e.g., as indicated by a file name suffix or extension), a database object type, a MIME type, or a uniform type identifier. Accordingly, in such implementations, for each object type supported by a computing system, an application can register one or more functions as available for surfacing the corresponding functionality through a contextual tool window. It should be understood, however, that associating an application or function with an object type may be accomplished by techniques other than registration, such as a URL scheme, passing of a GUID indicating a library entry point for the application and/or function, etc.

In some implementations, the display space available for presenting items in the context menu 220 may be limited. For example, in some cases, the context menu 220 may only have room for three items, even though fifteen functions for five different applications have registered for surfacing in relation to the object type of the object associated with the icon 202. As such, the function items presented in the context menu 220 may be filtered, and/or ranked based on a context, which may be determined based on various inputs, including without limitation the characteristics of the object (e.g., size, type, creation date, modification date, underlying data of the object, the owner of the object, the location in the storage environment), specified user preferences, and historical behavior of the user (and/or possibly other users) when interacting with an object of this type or with the specific object itself. For examples, if the user 204 typically calls or messages a person when selecting an icon for a contact object, then the telephony and messaging functions may be ranked higher than other available functions. In some implementations, other functions may be filtered out (e.g., not presented in the context menu 220), according to their relative rankings.

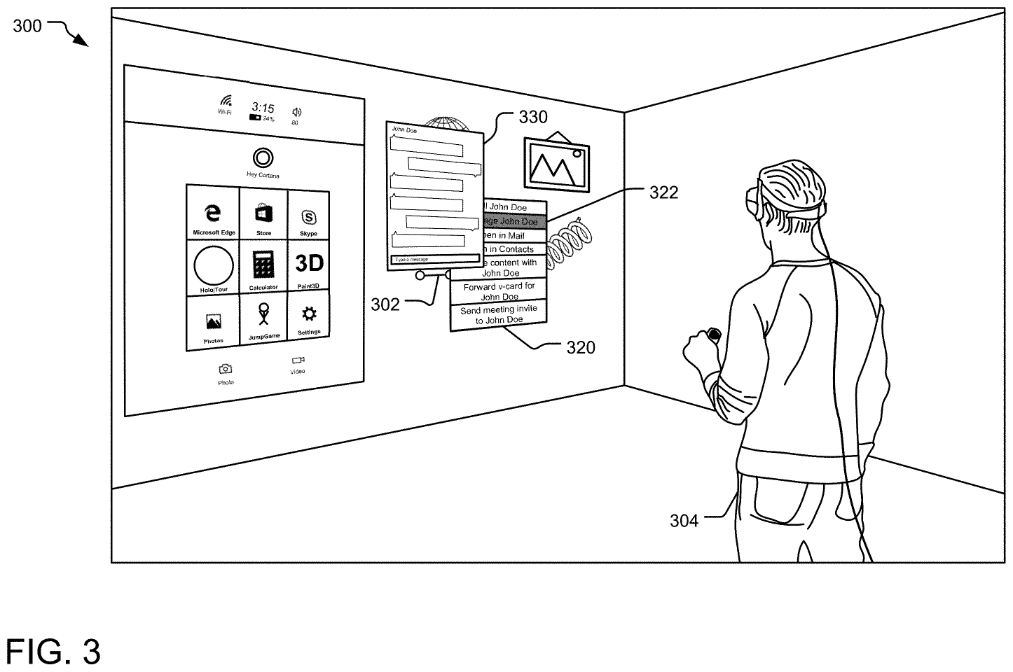

As shown in FIG. 2 by the darker fill in the context menu item 222 of the context menu 220, the user 204 has selected an available function “Message to John Doe” from a messaging application. By selecting the context menu item 222 in FIG. 2, the user 204 can trigger the surfacing of the corresponding functionality and its UI through a contextual tool window, as described with regard to FIG. 3.

FIG. 3 illustrates an example mixed/virtual reality environment 300 capable of surfacing application functionality for an object associated with a selected icon 302 through a contextual tool window 330. Responsive to the selection by the user 304 of the context menu item 322 in the context menu 320, the computing system accesses the application function associated with the selected context menu item 322 and presents a user interface (UI) for the associated function in the contextual tool window 330. In FIG. 3, the selected function is a messaging function of a messaging application, and a conversation user interface is presented in the contextual tool window 330. In addition to presenting the conversation user interface, the contextual tool windows 330 has been seeded with the contact “John Doe” so that the conversation presented in the contextual tool window 330 is between the user 304 and John Doe. Accordingly, the contextual tool window 330 surfaces functionality for a selected function of the messaging application based on the contact “John Doe,” which is extracted as a context from the underlying contact object. Contexts will be discussed in more detail with regard to other figures.

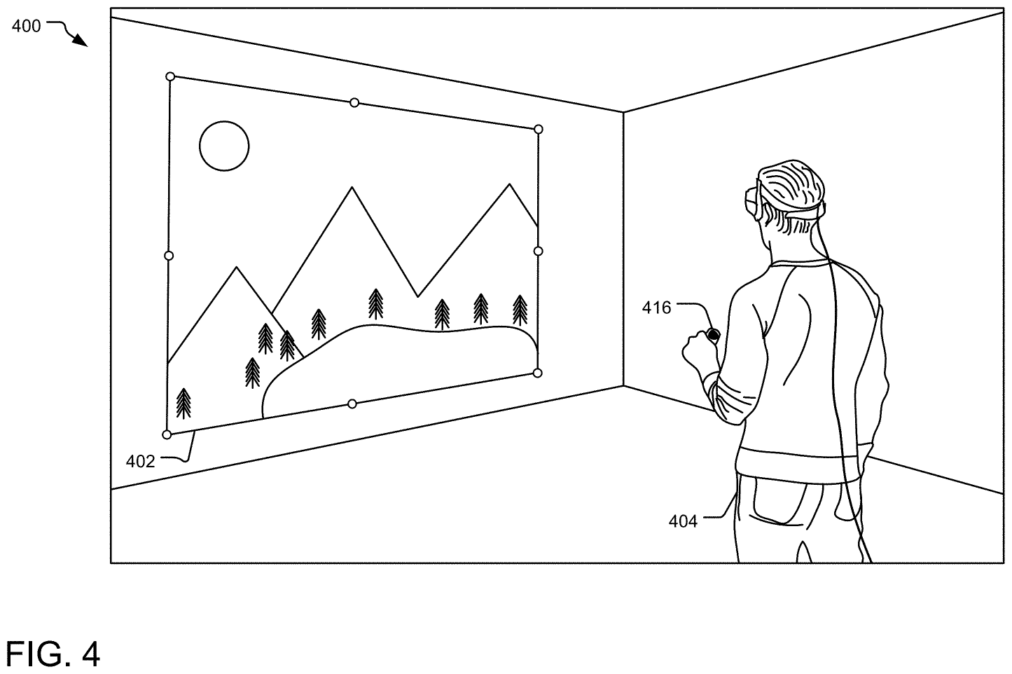

FIG. 4 illustrates an example mixed/virtual reality environment 400 capable of surfacing application functionality for a selected object 402. A user 404 is working in the mixed/virtual reality environment 400 and is presented with the object 402 having an object type “image.” Other possible object types associated with the object 402 may include without limitation “.png,” “public.jpeg,” “TIFF image,” “com.nikon.raw-image,” “com.adobe.photoshop-image,” and “com.microsoft.bmp.”

The user 404 selects the object 402 to perform some type of function on the associated data object. Selection of the object 402 represents giving the associated object focus, and may be accomplished through a variety of techniques, including using a VR control 416 to move focus to or select the object 402 (e.g., as shown by the circles distributed around the object 402, tabbing focus to the object 402 using a virtual keyboard). In a typical user scenario, the user 404 could launch an application in an application window to provide functionality on the object associated with the object 402. However, simply moving focus to the object 402 does not launch an application, application window, or any other application functionality of the associated data object.

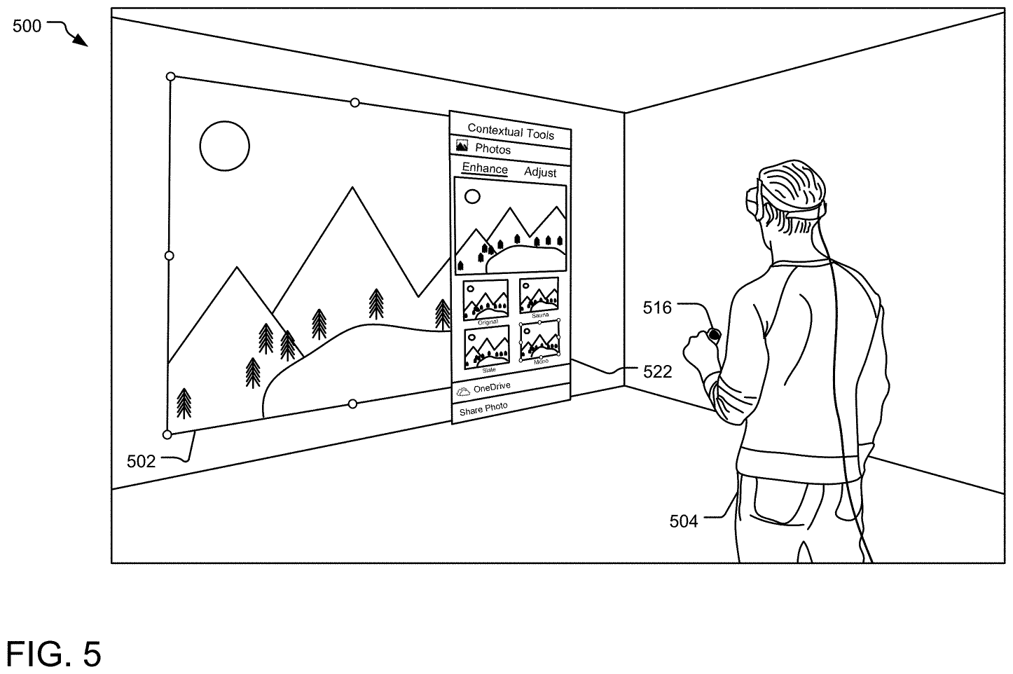

FIG. 5 illustrates an example mixed/virtual reality environment 500 capable of surfacing application functionality for a selected object 502. A user 504 can access functionality from one or more applications through the object 502 without launching the corresponding application in an application window or even switching focus to an application window of an already launched application. For example, using a control on a VR control 516 (e.g., an equivalent of a right-click on a mouse), the user 504 can trigger a contextual tool window 522, which presents a selection user interfaces of available functions from an image editing application (e.g., Photos) without launching an application window for the image editing application. The user interfaces offer an “Enhance” function and an “Adjust” function, with associated UI selections for Original, Sauna, Slate, and Mono in the contextual tool window. Another example function is partially shown - OneDrive with a function to share the photo. In various implementations, the applications and/or functions available for the object 502 have registered with the object type of the object associated with object 502. Ranking and filtering can be used to present the most likely “next” function according to historical user behavior and context.

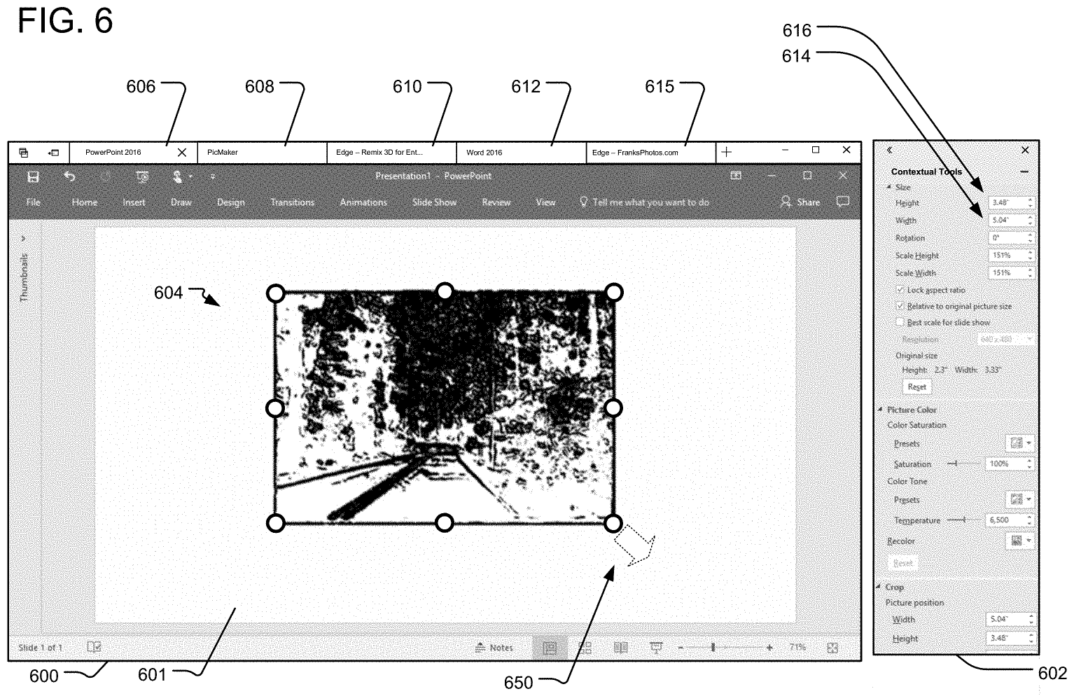

FIG. 6 illustrates an example desktop environment capable of surfacing application functionality for a selected image object 604 in an application through a separate contextual tool window 602, in a pre-operation phase. An active application window is a presentation editing application (such as PowerPoint®) within a set window 600. In some implementations, the set of windows may constitute a “set window,” as described herein, although other implementations may form a set of associated application windows using a shared property (such sharing a tag, being open in a common desktop or virtual desktop, or being part of a sharing session within a collaboration system) or other association technique. When reading a description of a figure using the term “set window,” it should be understood that a set window or any set of associated application windows may be employed in the described technology.

Multiple application windows can allow a user to collect, synchronize, and/or persist the applications, data, and application states in the given workflow, although all sets of associated application windows need not provide all of these benefits. In the illustrated example, a user has selected an image object 604 in a presentation slide 601. The set window 600 includes inactive applications 608, 610, 612, and 615. The active application window is indicated by the active tab 606 (the active application window is also referred to as the active application window 606), and four hidden applications windows are indicated by the inactive tabs 608, 610, and 612. The user can switch to any of the hidden application windows of the set window 600 by selecting one of the tabs or employing another window navigation control. It should be understood that individual application windows may be “detached” from the set window (e.g., removed from the displayed boundaries of the set window) and yet remain “in the set window” as members of the associated application windows of the set window.

Predictive application functionality surfacing can surface functionality from the active application window 606 or any other application based on the user's activity within the set window 600. Available functionality is, for example, identified by a registration or association of an application and/or the associated function(s) the application has available for surfacing through a contextual tool window 602. The user's activity within the set window 600 may include activity in the active application window 606 or previous activity in the inactive tabs 608, 610, and 612. For example, in the illustrated example, a user has selected the image object 604 in the presentation slide 601. As a result, image editing functionality from the active application window is surfaced, and user interface elements for the surfaced image editing functionality are displayed on the contextual tool window 602. For example, a height adjustment control 614 and a width adjustment control 616 are displayed on the contextual tool window 602. It should be understood, however, that functionality from a different application or application window may also be surfaced through the contextual tool window 602.

The prediction of which functionality to surface may be based at first on controls that a typical user may select when engaging with a particular object or type of object in a particular context. For example, the height adjustment control 614 and the width adjustment control 616 may not be surfaced when a typical user selects text in a presentation slide. However, if a specific user frequently uses the height adjustment control 614 and the width adjustment control immediately after selecting the image object 604 or an object of the same object type in a presentation slide, the height adjustment control 614 and the width adjustment control 616 may be surfaced and displayed in the contextual tool window 602 for the specific user. In the example shown in FIG. 6, the dotted-line arrow 650 indicates a direction of a size adjustment that can be made through the contextual tool windows 602 on the image object 604.

The predicted surface-able functionality may be chosen from a set of surface-able functionality identified by the active application window 606 during a registration operation. In some implementations, the applications executing in the application windows 608, 610, and 612 also register functionality during the registration operation. Registration occurs when the active application 606 communicates surface-able functionality and the user interface (UI) for controls for the surface-able functionality to the functionality register. For example, the active application 606 may communicate a globally unique identifier (GUID) to the functionality register. The functionality register may use the communicated GUID to identify the surface-able functionality. Instead of the functionality of the active application window 606, functionality of a different application or application window may be surfaced through the contextual tool window 602.

User interface elements associated with the predicted surface-able functionality are presented in the contextual tool window 602 separate from the set window 600 and the active application 606. For example, in FIG. 6, controls for changing the size of the image of the image object 604, changing the color of the image object 604, and cropping the image object 604 are presented in the contextual tool window 602. The controls are presented using the UIs received during the registration of the active application 606 corresponding to the predicted surface-able functionality. The UIs may be specially formatted for the contextual tool window 602 or may be similar to UIs within the active application 606.

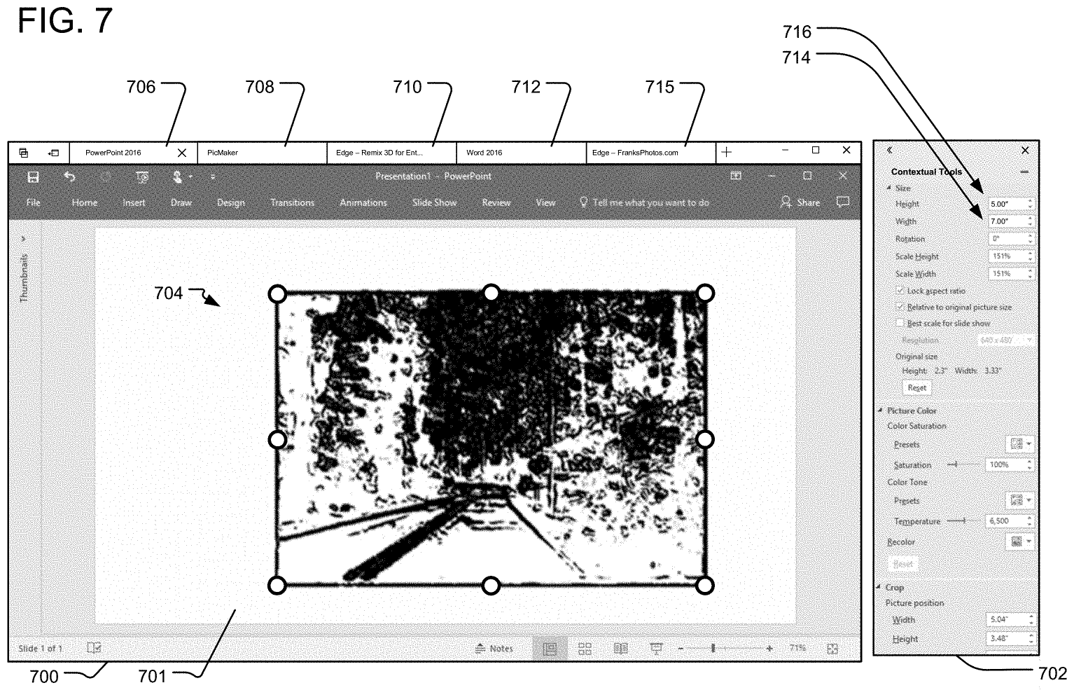

FIG. 7 illustrates an example desktop environment capable of surfacing application functionality for a selected object 704 in an application through a separate contextual tool window 702, in a post-operation phase. The set window 700 includes an active application 706 and inactive applications 708, 710, 712, and 715. Previously, user interface elements corresponding to predicted surface-able functionality were presented in the contextual tool window 702 after an image object 704 was selected in a presentation slide 701. After the controls are presented in the contextual tool window 702, user selection of the controls is detected.

A height adjustment control 714 and a width adjustment control 716 are presented in the contextual tool window 702. As shown in FIG. 7, the user has selected and interacted with the height adjustment control 714 and the width adjustment control 716 to adjust the size of the image object 704 on the presentation slide 701. The user's interaction with the height adjustment control 714 and the width adjustment control 716 is detected. In some implementations, the user may interact multiple times with a single control. For example, the user may use the arrows that are part of the height adjustment control 714 to adjust the size of the image object 704 several times. After selection of or interaction with the height adjustment control 714 and the width adjustment control 716 are detected, the active application 706 executes the functions corresponding to the height adjustment control 714 and the width adjustment control 716. In some implementations, further functions may be surfaced based on the controls selected by the user.

Instead of the functionality of the active application window 706, functionality of a different application or application window may be surfaced through the contextual tool window 702.

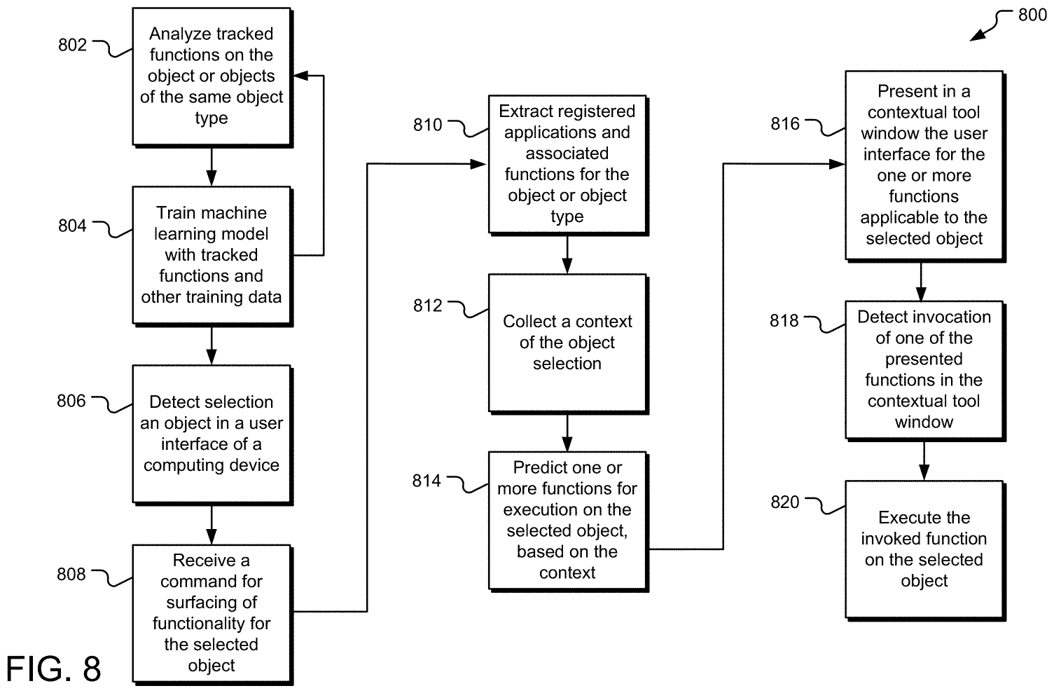

FIG. 8 illustrates an example flow of operations 800 for surfacing application functionality for an object. The contextual tool window technology described herein can track historical functions executed by the user and/or other users on the same object and/or on the same object type in order to determine a context and/or training data for that object or object type. For example, in a training phase, the object and/or the object type can be considered observations as training data in a machine learning environment, and these historical functions can be considered labels for the training data. The training data can then be used to train a machine learning model of a function predictor to select appropriate functions UIs (user interfaces) for presentation to the user through the contextual tool window.

An analyzing operation 802 tracks historical “next” functions invoked by the user and/or other users on the object and/or objects having the same or similar object type. As such, the historical “next” functions invoked by users constitute “labels” associated with the “observations,” the selected objects. Other information may also be analyzed as context (e.g., observations) in the analyzing operation 802 including without limitation the object itself, the object type, the time of day the object is selected, the network to which the user is connected, the user's location, and the computing interface through which the user has selected the object (e.g., a mobile device, a desktop system, a remote desktop, and a mixed/virtual reality interface). All of these factors may be collected to define a context from which a functionality surfacing system can predict appropriate function user interfaces to present to the user through the contextual tool window. A training operation 804 inputs the tracked “next” functions and other training data, such as object identity, object type, and other contextual information, in one implementation, into a machine learning model to train the model. In a machine learning environment, a context in the training operation 804 acts as a labeled observation, where the tracked “next” functions act as the corresponding labels. The analyzing operation 802 and the training operation 804 can loop as new training data becomes available. In some implementation, predictions in a prediction operation 814 may not employ such analysis and training operations, but they are described herein as examples.

A detection operation 806 detects selection of an object in a user interface of a computing device. In the example shown in FIG. 1, the icon 102 for an object is selected (an example of selecting the object). In FIG. 3, the object 402 is selected. In FIG. 6, the image object 604 is selected. In various implementations, a user interface controller (or another associated controller) detects such selections and identifies the objects and their characteristics (e.g., the location of the icon or object, storage location, etc.).

A receiving operation 808 receives a command for surfacing functionality for the selected object. For example, a right-click on the object may trigger presentation of a context menu offering a selection of functions that can be surfaced in a contextual tool window. In another example, a user interface command from the user may directly open or change focus to a contextual tool window that presents the user interface for one or more functions for one or more applications. Rather than launching the application and opening an application window for the application's user interface, a user interface for the function is presented in the contextual tool window. This method of surfacing the functionality (e.g., user interface of a function) without launching the application in the associated application can reduce resource and processor utilization and energy draw. Furthermore, mixed/virtual reality computing environments can be more data or object intensive, as opposed to application intensive, when compared to traditional computing environments. In a similar fashion, mobile computing environments, particularly when considering energy usage, can benefit from reducing the processor utilization and display real estate occupied by full window applications.

An extracting operation 810 selects the applications and/or functions associated with the selected object or the object type of the selected object. In one implementation, the extracting operation 810 examines a registry that maps applications and/or functions to the object or object type. The functions mapped to the object or object type are deemed selected functions for possible presentation to the user in a contextual tool window of the user interface of the computing device.

A collecting operation 812 determines a context for the selected object. A context in the collecting operation 812 acts as an unlabeled observation, as do the object itself and/or the object type. An example context may include one or more of the following without limitation: object contents, features extracted from the object, an object type, the time of day the object is selected, the network to which the user is connected, the user's location, and the computing interface through which the user has selected the object (e.g., a mobile device, a desktop system, a remote desktop, and a mixed/virtual reality interface).

By analyzing the user's past behavior (e.g., using a trained machine learning model), the predicting operation 814 can predict one or more functions a user is more likely to invoke with respect to a selected object or the object type of the selected object and the collected context. For example, if the user frequently invokes a print command after selecting an object (or when opening an object in an application), then the prediction operation 814 can present a print function dialogue box in the contextual tool window. In a similar way, by aggregating and analyzing the past behavior of other users with objects of the same object type (or a similar object type), the prediction operation 814 can predict one or more functions a user is more likely to invoke or may like to discover with respect to a selected object or the object type of the selected object. For example, if another user frequently invokes a messaging command after selecting an object (or when opening an object in an application), then the prediction operation 814 can present a messaging function dialogue box in the contextual tool window.

Given the collected context, the prediction operation 814 receives the selected object and/or object type and other contextual information and outputs a ranked list of functions (or similar information regarding the functions) to a contextual tool controller, for selective presentation in the contextual tool windows. In one implementation, the prediction operation 814 uses a machine learning model training by the training operation 804, although other prediction techniques may be employed (e.g., decision trees, classification algorithms, neural networks).

A presenting operation 816 presents the predicted functions via their respective UIs in a contextual tool window. The presenting operation 816 may also filter, re-rank or modify the selected predicted functions. For example, if the machine learning model output ten highest-ranked functions, the contextual tool controller may determine that one of the functions cannot be displayed in the contextual tool window of the current computing device display (e.g., not enough display real estate) or cannot/should not be executed on the current computing device (e.g., the function requires pen input, and the computing device does not support pen input). In another example, the contextual tool controller may re-rank the presented functions, such as when a resource (e.g., a camera) for a function is not yet available—re-ranking can be dynamic so that the function becomes more highly ranked when the resource becomes available. In yet another example, the function can be modified to access different user preferences, such as redirection of a function output to a different output device (e.g., requesting the user for a different printer). Therefore, the contextual tool controller receives the UIs for the predicted functions and presents the selected function UIs through a user interface controller for the current computing device, in a contextual tool windows, without launching the associated application in an application window or shifting focus to the application window of the associated application, if already launched.

A detection operation 818 detects invocation of one of the presented functions through the contextual tool window, such as detecting a user action selecting or operating one of the presented functions within the contextual tool menu. An execution operation 820 executes the invoked function on the selected object without launching the associated application in an application window or shifting focus to the application window of the associated application, if already launched.

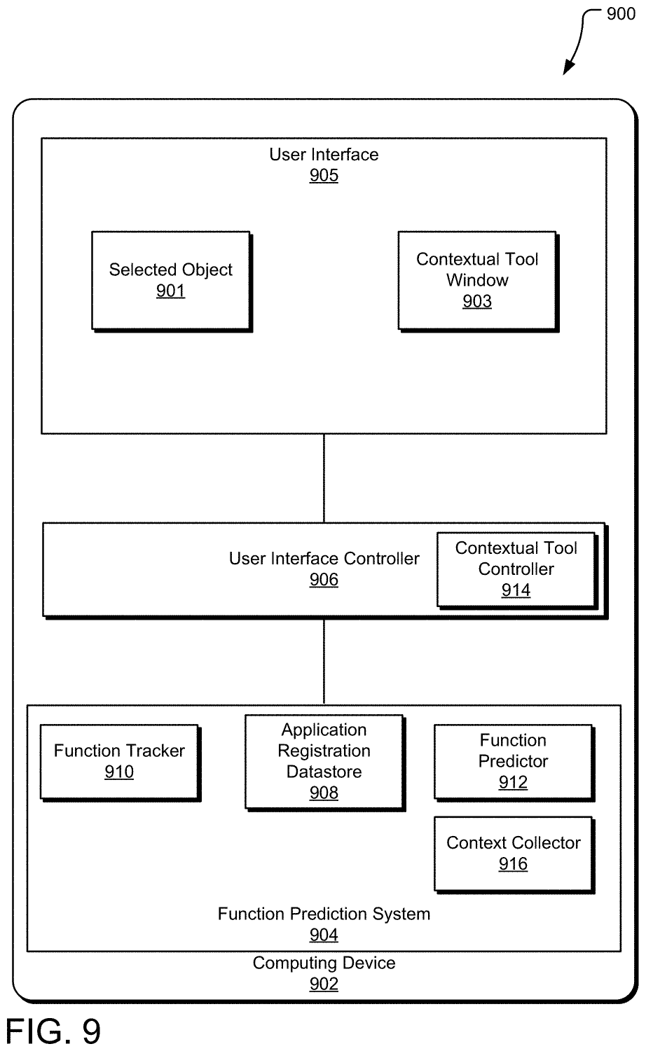

FIG. 9 illustrates an example system 900 for surfacing application functionality for an object. A computing device 902 includes a function prediction system 904 and a user interface controller 906. The function prediction system 904 includes an application registration datastore 908, which stores mappings between objects and/or object types and functions (and possibly applications) available for surfacing through a contextual tool window 903 of a user interface 905 of the computing device 902. For example, in one implementation, the extracting operation 810 of FIG. 8 could analyze the application registration datastore 908 to extract the available functions for a selected object. The application registration datastore 908 can also store user interface specifications defining the user interface to be used when presenting each registered function in the contextual tool window. In other implementations, the user interface specifications can be accessed via a GUID to an application library or other datastore.

The function prediction system 904 also includes a function tracker 910, which is configured to track the user's historical “next functions” after selecting objects through the user interface 905, and a context collector 916, which collects historical contexts about the selected objects. In one implementation, the tracked functions and collected context about the selected objects may be used to train a machine learning model, although the track functions may be used as input to a different type of prediction system.

The function prediction system 904 also includes a function predictor 912. In a training phase, the function predictor 912 can input the object types of the historically selected object 901 (and possibly the objects themselves) along with the historical tracked “next functions,” collected context of the historically selected objects to train a machine learning model. In a prediction phase, the function predictor 912 can input the object type of a currently selected object (and possibly the object itself) along with the collected context of the historically selected objects to predict the available “next functions” to present to the user in the contextual tool window 903.

In one implementation, these available next functions are passed through a contextual tool controller 914 in a user interface controller 906 to present in the contextual tool window 903, although the contextual tool controller 914 may be separated from the user interface controller 906. In one implementation, the functions may be passed via a GUID into a library used by the application to which the function is associated, although other “hooks” into the application functionality may be employed. The contextual tool controller 914 also processes user input through the contextual tool windows 903, such a selection (or invocation) of one of the presented functions. The contextual tool controller 914 detects the selection (or invocation) of the selected function and executes the function on the selected object without launching the associated application in an application window or shifting focus to the application window of the associated application, if already launched.

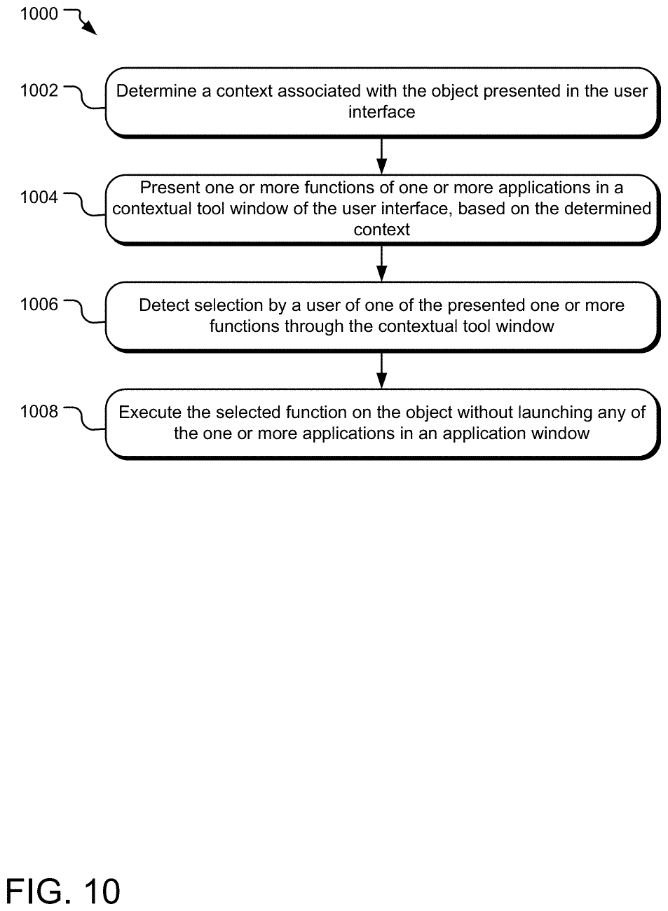

FIG. 10 illustrates example operations 1000 for surfacing application functionality for an object. A context operation 1002 determines a context associated with the object presented in the user interface. A presenting operation 1004 presents one or more functions of one or more applications in a contextual tool window of the user interface, based on the determined context, without launching any of the one or more applications in an application window. A selection operation 1006 detects selection by a user of one of the presented one or more functions through the contextual tool window. An execution operation 1008 executes the selected function on the object without launching any of the one or more applications in an application window.

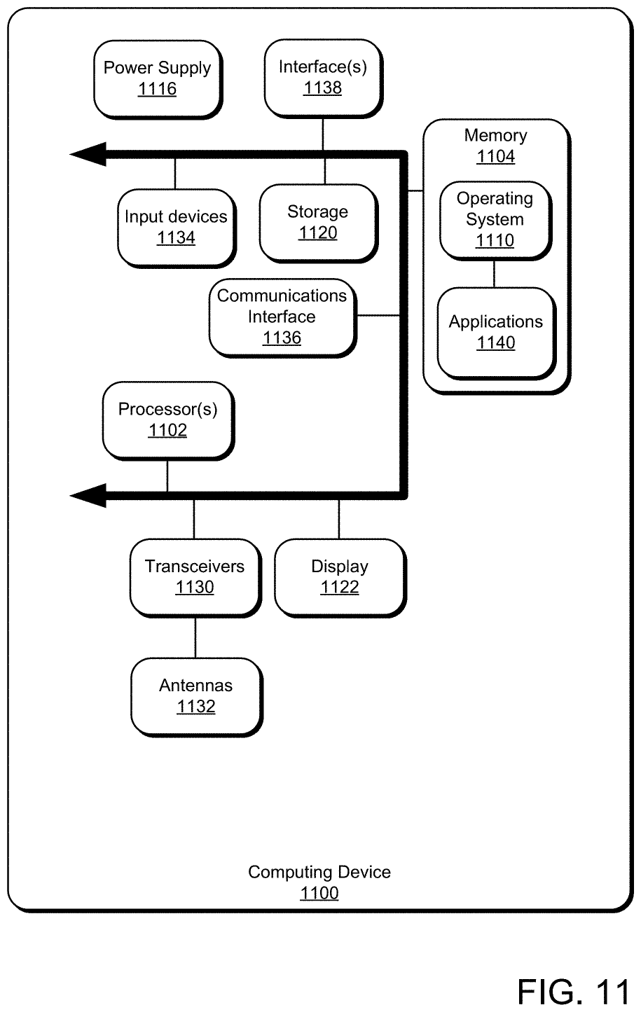

FIG. 11 illustrates an example computing device that may be useful in implementing the described technology. The example computing device 1100 may be used to detect the proximity of an object with respect to an antenna, such as inter-application context seeding. The computing device 1100 may be a personal or enterprise computing device, such as a laptop, mobile device, desktop, tablet, or a server/cloud computing device. The computing device 1100 includes one or more processor(s) 1102, and a memory 1104. The memory 1104 generally includes both volatile memory (e.g., RAM) and non-volatile memory (e.g., flash memory). An operating system 1110 and one or more applications 1140 reside in the memory 1104 and are executed by the processor(s) 1102.

One or more modules or segments, such as contextual tool controller, a function tracker, a function predictor and other components, are loaded into the operating system 1110 on the memory 1104 and/or storage 1120 and executed by the processor(s) 1102. Data such as contexts, an application registration datastore, and other data and objects may be stored in the memory 1104 or storage 1120 and may be retrievable by the processor(s). The storage 1120 may be local to the computing device 1100 or may be remote and communicatively connected to the computing device 1100.

The computing device 1100 includes a power supply 1116, which is powered by one or more batteries or other power sources and which provides power to other components of the computing device 1100. The power supply 1116 may also be connected to an external power source that overrides or recharges the built-in batteries or other power sources.

The computing device 1100 may include one or more communication transceivers 1130 which may be connected to one or more antenna(s) 1132 to provide network connectivity (e.g., mobile phone network, Wi-Fi®, Bluetooth®) to one or more other servers and/or client devices (e.g., mobile devices, desktop computers, or laptop computers). The computing device 1100 may further include a network adapter 1136, which is a type of communication device. The computing device 1100 may use the adapter and any other types of communication devices for establishing connections over a wide-area network (WAN) or local-area network (LAN). It should be appreciated that the network connections shown are exemplary and that other communications devices and means for establishing a communications link between the computing device 1100 and other devices may be used.

The computing device 1100 may include one or more input devices 1134 such that a user may enter commands and information (e.g., a keyboard or mouse). These and other input devices may be coupled to the server by one or more interfaces 1138 such as a serial port interface, parallel port, or universal serial bus (USB). The computing device 1100 may further include a display 1122 such as a touchscreen display.

The computing device 1100 may include a variety of tangible processor-readable storage media and intangible processor-readable communication signals. Tangible processor-readable storage can be embodied by any available media that can be accessed by the computing device 1100 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 1100. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

An example method of surfacing application functionality for an object in a user interface of a computing device includes determining a context associated with the object presented in the user interface, and presenting, in a contextual tool window of the user interface, user interfaces for one or more functions of one or more applications, based on the context, without launching any of the one or more applications in an application window detecting through the contextual tool window in the user interface selection by a user of one of the presented one or more functions. The method also includes executing the selected function on the object without launching any of the one or more applications in an application window.

Another example method of any preceding method further includes registering the one or more applications and the one or more functions of the one or more applications with an object type associated with the object, before the operation of presenting in a contextual tool window.

Another example method of any preceding method further includes registering a user interface specification associated with each of the one or more functions, each user interface specification defining presentation through the user interface of each function of the one or more registered functions in the contextual tool window.

Another example method of any preceding method is provided wherein the determining operation includes detecting selection of the object in the user interface and determining a context associated with the selection of the object, responsive to detecting the selection of the object.

Another example method of any preceding method is provided wherein the presenting operation includes generating a ranking of the one or more functions based on the context and presenting in a contextual tool window of the user interface one or more highest ranking functions of the one or more ranked functions.

Another example method of any preceding method is provided wherein the determining operation includes determining a context based on historical tracked operations on the object.

Another example method of any preceding method is provided wherein the determining operation includes determining a context based on historical tracked operations on objects of the same object type as the object.

Another example method of any preceding method is provided wherein the determining operation includes determining a context based on historical tracked operations of the user.

Another example method of any preceding method is provided wherein the determining operation includes determining a context based on historical tracked operations of other users.

An example system for surfacing application functionality for an object in a user interface of a computing device includes one or more processors, a context collector executed by the one or more processors and configured to determine a context associated with the object presented in the user interface, and a contextual tool controller executed by the one or more processors and configured to present, in a contextual tool window of the user interface, user interfaces for one or more functions of one or more applications, based on the context, without launching any of the one or more applications in an application window. A user interface controller is executed by the one or more processors and configured to detect through the contextual tool window in the user interface selection by a user of one of the presented one or more functions and to execute the selected function on the object without launching any of the one or more applications in an application window.

Another system of any preceding system further includes an application registration datastore configured to register the one or more applications and the one or more functions of the one or more applications with an object type associated with the object, before presenting in a contextual tool window.

Another system of any preceding system further includes an application registration datastore configured to register the one or more applications, the one or more functions of the one or more applications with an object type associated with the object, and a user interface specification associated with each of the one or more functions. Each user interface specification defines presentation through the user interface of each function in the contextual tool window, before presenting in a contextual tool window.

Another system of any preceding system is provided wherein the context collector is further configured to detect selection of the object in the user interface and to determine a context associated with the selection of the object.

Another system of any preceding system further includes a function predictor executed by the one or more processors and configured to generate a ranking of the one or more functions based on the context, and the contextual tool controller is further configured to present in a contextual tool window of the user interface one or more highest ranking functions of the one or more ranked functions.

One or more example tangible processor-readable storage media of a tangible article of manufacture encoding processor-executable instructions is provided for executing on an electronic computing system a process surfacing application functionality for an object in a user interface of a computing device. The process includes determining a context associated with the object presented in the user interface, presenting, in a contextual tool window of the user interface, user interfaces for one or more functions of one or more applications, based on the context, without launching any of the one or more applications in an application window, detecting through the contextual tool window in the user interface selection by a user of one of the presented one or more functions, executing the selected function on the object without launching any of the one or more applications in an application window.

Other example tangible processor-readable storage media of any preceding storage media are provided wherein the process further includes registering the one or more applications and the one or more functions of the one or more applications with an object type associated with the object, before the operation of presenting in a contextual tool window.

Other example tangible processor-readable storage media of any preceding storage media are provided wherein the determining operation includes detecting selection of the object in the user interface and determining a context associated with the selection of the object, responsive to detecting the selection of the object.

Other example tangible processor-readable storage media of any preceding storage media are provided wherein the presenting operation includes generating a ranking of the one or more functions based on the context and presenting in a contextual tool window of the user interface one or more highest ranking functions of the one or more ranked functions.

Other example tangible processor-readable storage media of any preceding storage media are provided wherein the registering operation includes registering a user interface specification associated with each of the one or more functions, each user interface specification defining presentation through the user interface of each function of the one or more registered functions in the contextual tool window.

Other example tangible processor-readable storage media of any preceding storage media are provided wherein the determining operation includes determining a context based on historical tracked operations of on the object or objects of the same object type.

An example system for surfacing application functionality for an object in a user interface of a computing device includes means for determining a context associated with the object presented in the user interface and means for presenting, in a contextual tool window of the user interface, user interfaces for one or more functions of one or more applications, based on the context, without launching any of the one or more applications in an application window detecting through the contextual tool window in the user interface selection by a user of one of the presented one or more functions. The system also includes means for executing the selected function on the object without launching any of the one or more applications in an application window.

Another example system of any preceding system further includes means for registering the one or more applications and the one or more functions of the one or more applications with an object type associated with the object, before presenting in a contextual tool window.

Another example system of any preceding system further includes means for registering a user interface specification associated with each of the one or more functions, each user interface specification defining presentation through the user interface of each function of the one or more registered functions in the contextual tool window.

Another example system of any preceding system is provided wherein the means for determining includes means for detecting selection of the object in the user interface and determining a context associated with the selection of the object, responsive to detecting the selection of the object.

Another example system of any preceding system is provided wherein the means for presenting includes means for generating a ranking of the one or more functions based on the context and means for presenting in a contextual tool window of the user interface one or more highest ranking functions of the one or more ranked functions.

Another example system of any preceding system is provided wherein the means for determining includes means for determining a context based on historical tracked operations on the object.

Another example system of any preceding system is provided wherein the means for determining includes means for determining a context based on historical tracked operations on objects of the same object type as the object.

Another example system of any preceding system is provided wherein the means for determining includes means for determining a context based on historical tracked operations of the user.

Another example system of any preceding system is provided wherein the means for determining includes means for determining a context based on historical tracked operations of other users.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

1. A method of surfacing application functionality for an object in a user interface of a computing device, the method comprising:
registering one or more applications and one or more functions of the one or more applications with an object type associated with the object
determining a context associated with the object presented in the user interface;
presenting, in a contextual tool window of the user interface, user interfaces for execution of the registered one or more functions of one or more applications on the object, based on the context, without launching any of the registered one or more applications in an application window;
detecting through the contextual tool window in the user interface selection by a user of one of the presented one or more functions from the registered one or more functions; and
executing the selected function on the object without launching any of the registered one or more applications in an application window.

2. The method of claim 1 wherein the registering operation is executed before the operation of presenting in a contextual tool window.

3. The method of claim 1 further comprising:
registering a user interface specification associated with each of the one or more functions, each user interface specification defining presentation through the user interface of each function of the one or more registered functions in the contextual tool window.

4. The method of claim 1 wherein the determining operation comprises:
detecting selection of the object in the user interface; and
determining a context associated with the selection of the object, responsive to detecting the selection of the object.

5. The method of claim 1 wherein the presenting operation comprises:
generating a ranking of the one or more functions based on the context; and
presenting in a contextual tool window of the user interface one or more highest ranking functions of the one or more ranked functions.

6. The method of claim 1 wherein the determining operation comprises:
determining a context based on historical tracked operations on the object.

7. The method of claim 1 wherein the determining operation comprises:
determining a context based on historical tracked operations on objects of the same object type as the object.

8. The method of claim 1 wherein the determining operation comprises:
determining a context based on historical tracked operations of the user.

9. The method of claim 1 wherein the determining operation comprises:
determining a context based on historical tracked operations of other users.

10. A system for surfacing application functionality for an object in a user interface of a computing device, the system comprising:
one or more processors;
an application registration hardware datastore configured to register one or more applications and one or more functions of the one or more applications with an object type associated with the object;
a context collector executed by the one or more processors and configured to determine a context associated with the object presented in the user interface;
a contextual tool controller executed by the one or more processors and configured to present, in a contextual tool window of the user interface, user interfaces for execution of the registered one or more functions of one or more applications on the object, based on the context, without launching any of the registered one or more applications in an application window; and
a user interface controller executed by the one or more processors and configured to detect through the contextual tool window in the user interface selection by a user of one of the presented one or more functions from the registered one or more functions and to execute the selected function on the object without launching any of the registered one or more applications in an application window.

11. The system of claim 10
wherein the application registration hardware datastore is configured to register the one or more applications and the one or more functions of the one or more applications with the object type associated with the object before presenting in a contextual tool window.

12. The system of claim 10 further comprising:
an application registration hardware datastore configured to register the one or more applications, the one or more functions of the one or more applications with an object type associated with the object, and a user interface specification associated with each of the one or more functions, each user interface specification defining presentation through the user interface of each function in the contextual tool window, before presenting in a contextual tool window.

13. The system of claim 10 wherein the context collector is further configured to detect selection of the object in the user interface and to determine a context associated with the selection of the object.

14. The system of claim 10 further comprising:
a function predictor executed by the one or more processors and configured to generate a ranking of the one or more functions based on the context, and the contextual tool controller is further configured to present in a contextual tool window of the user interface one or more highest ranking functions of the one or more ranked functions.

15. One or more tangible processor-readable storage media of a tangible article of manufacture encoding processor-executable instructions for executing on an electronic computing system a process surfacing application functionality for an object in a user interface of a computing device, the process comprising:
registering one or more applications and one or more functions of the one or more applications with an object type associated with the object;
determining a context associated with the object presented in the user interface;
presenting, in a contextual tool window of the user interface, user interfaces for execution of the registered one or more functions of one or more applications on the object, based on the context, without launching any of the registered one or more applications in an application window;
detecting through the contextual tool window in the user interface selection by a user of one of the presented one or more functions from the registered one or more functions; and
executing the selected function on the object without launching any of the registered one or more applications in an application window.

16. The one or more tangible processor-readable storage media of claim 15 wherein the
registering the one or more applications and the one or more functions of the one or more applications with an object type associated with the object is before the operation of presenting in a contextual tool window.

17. The one or more tangible processor-readable storage media of claim 15 wherein the determining operation comprises:
detecting selection of the object in the user interface; and
determining a context associated with the selection of the object, responsive to detecting the selection of the object.

18. The one or more tangible processor-readable storage media of claim 15 wherein the presenting operation comprises:
generating a ranking of the one or more functions based on the context; and
presenting in a contextual tool window of the user interface one or more highest ranking functions of the one or more ranked functions.

19. The one or more tangible processor-readable storage media of claim 15 wherein the registering operation comprises:
registering a user interface specification associated with each of the one or more functions, each user interface specification defining presentation through the user interface of each function of the one or more registered functions in the contextual tool window.

20. The one or more tangible processor-readable storage media of claim 15 wherein the determining operation comprises:
determining a context based on historical tracked operations of on the object or objects of the same object type.
